(19) United States
(12) Patent Application Publication
(10) Pub. No.: US 2024/0011599 A1
(43) Pub. Date: Jan. 11, 2024

(54) Removable Shutter Assembly

(71) Applicant: Kristopher Page, Attalla, AL (US)

(72) Inventor: Kristopher Page, Attalla, AL (US)

(21) Appl. No.: 17/860,681

(22) Filed: Jul. 8, 2022

(51) Int. Cl. F16M 13/02; F16B 5/12

(52) U.S. Cl. CPC F16M 13/02; F16B 5/123

(57) ABSTRACT

A removable shutter assembly includes a pair of brackets that is each attachable to an exterior wall of a building. Each of the brackets is positionable adjacent to a window in the exterior wall. Each of the brackets has a first panel that is perpendicularly oriented with a second panel. A shutter is positionable between the pair of brackets. The shutter has a pair of attachments movably integrated into the shutter. Each of the attachments is biased into an engaging condition to releasably engage a respective one of the brackets thereby facilitating the shutter to be quickly coupled to the pair of brackets. Each of the attachments is urgeable into a releasing condition to disengage the respective bracket thereby facilitating the shutter to be quickly removed from the pair of brackets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shutter devices and more particularly pertains to a new shutter device for removably attaching a shutter to an exterior wall of a building. The device includes a first bracket and a second bracket that are each attachable to the exterior wall. The first bracket has a pair of wells and the second bracket has a pair of first pins. The device includes a shutter which has a pair of recesses and a pair of second pins that are movably attached to the shutter. Each of the second pins engages a respective well in the first bracket and each of the first pins engages a respective recess in the shutter for removably attaching the shutter between the first bracket and the second bracket.

### (2) Description of Related Art Including Information Disclosed Under 37 CFR 1.97 and 1.98

The prior art relates to shutter devices including a window shutter that includes a mounting bracket attached to a wall and a locking member that is removably attachable to the mounting bracket. The prior art discloses an ornamental shutter which is attachable to a wall with fasteners. The prior art discloses a decorative shutter device that includes a shutter and a fastener which engages the shutter and pre-formed hole in a wall for attaching the shutter to the wall. The prior art discloses a shutter which can be cut to a desired length and a pair of end caps that are attachable to either end of the shutter. The prior art discloses a decorative shutter cover that is attachable to an existing shutter and an attachment member which engages a top end of the existing shutter.

### BRIEF SUMMARY OF THE INVENTION

An embodiment of the disclosure meets the needs presented above by generally comprising a pair of brackets that is each attachable to an exterior wall of a building. Each of the brackets is positionable adjacent to a window in the exterior wall. Each of the brackets has a first panel that is perpendicularly oriented with a second panel. A shutter is positionable between the pair of brackets. The shutter has a pair of attachments movably integrated into the shutter. Each of the attachments is biased into an engaging condition to releasably engage a respective one of the brackets thereby facilitating the shutter to be quickly coupled to the pair of brackets. Each of the attachments is urgeable into a releasing condition to disengage the respective bracket thereby facilitating the shutter to be quickly removed from the pair of brackets.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a removable shutter assembly according to an embodiment of the disclosure.

FIG. 2 is a front exploded view of an embodiment of the disclosure.

FIG. 3 is a left side exploded perspective view of an embodiment of the disclosure.

FIG. 4 is a perspective in-use view of an embodiment of the disclosure.

### DETAILED DESCRIPTION OF THE INVENTION

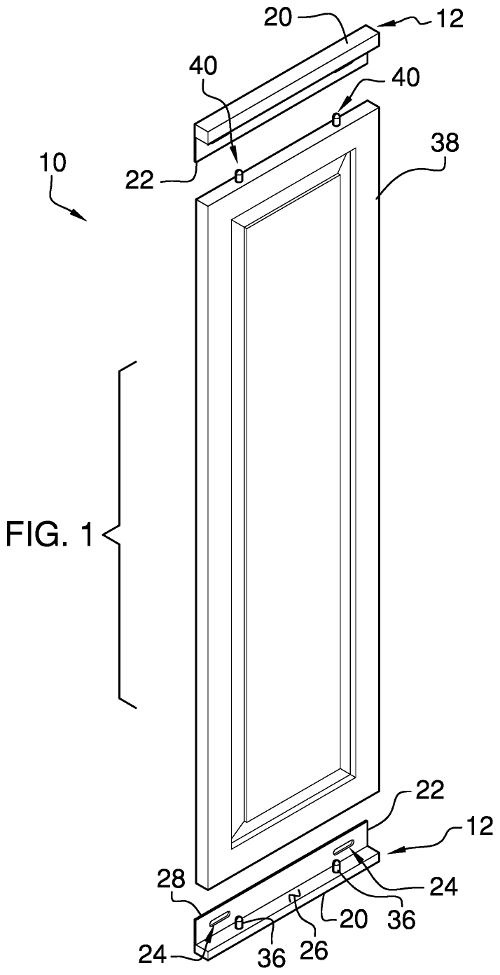

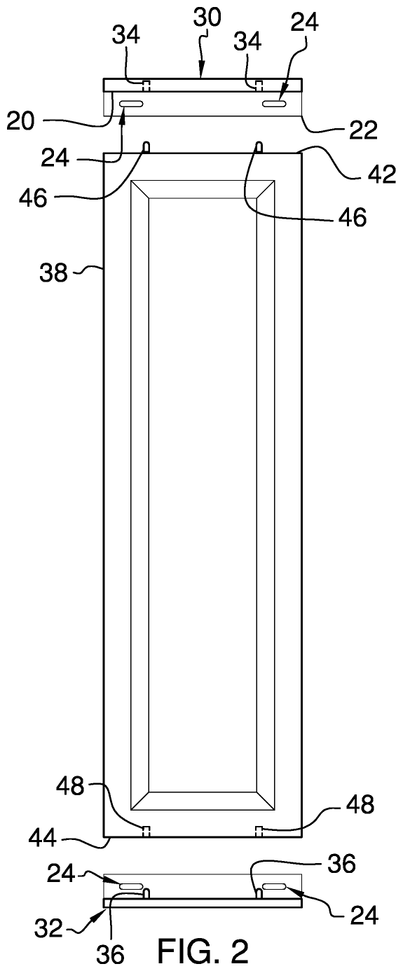

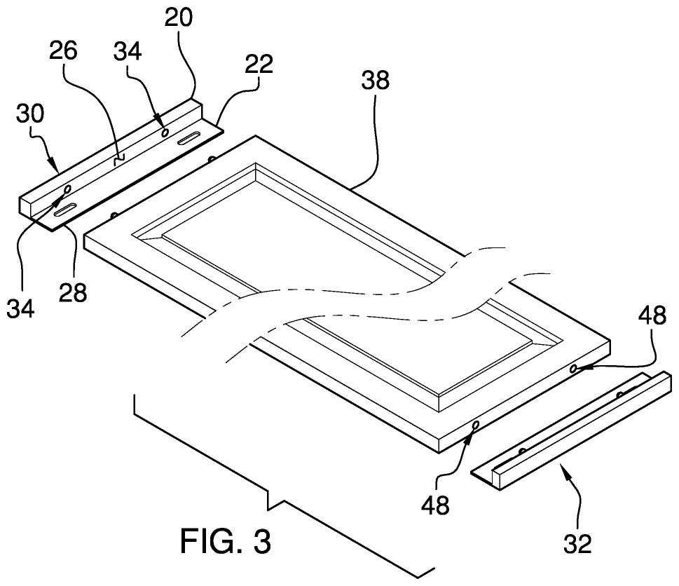

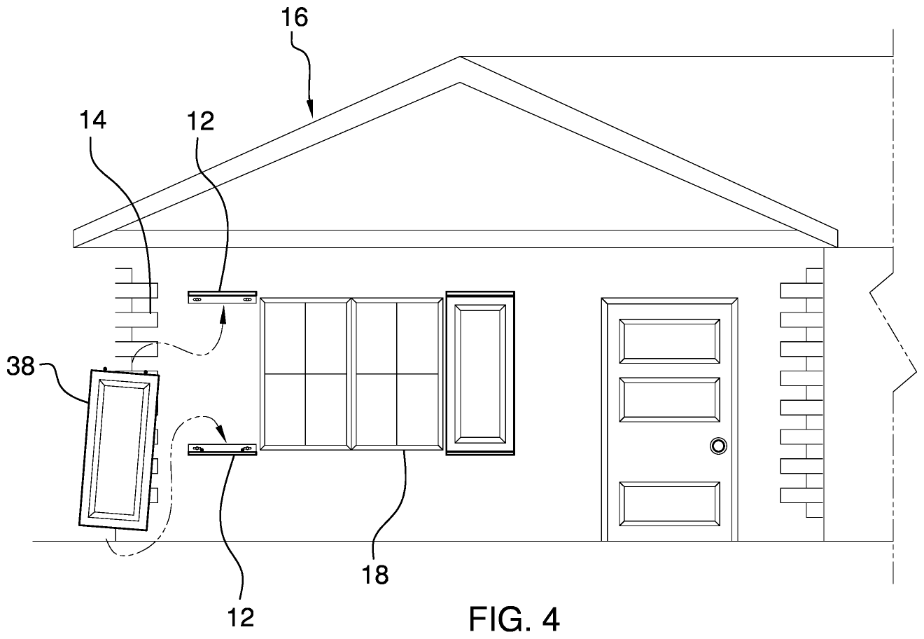

With reference now to the drawings, and in particular to FIGS. 1 through 4 thereof, a new shutter device embodying the principles and concepts of an embodiment of the disclosure and generally designated by the reference numeral 10 will be described.

As best illustrated in FIGS. 1 through 4, the removable shutter assembly 10 generally comprises a pair of brackets 12 that are each attachable to an exterior wall 14 of a building 16 and each of the brackets 12 is positionable adjacent to a window 18 in the exterior wall 14. Each of the brackets 12 has a first panel 20 that is perpendicularly oriented with a second panel 22 and each of the brackets 12 has a pair of slots 24 each integrated into the second panel 22. The slots 24 in the second panel 22 of each of the brackets 12 are elongated such that each of the slots 24 has an ovoid shape extending laterally along the second panel 22. The first panel 20 of each of the brackets 12 has a first surface 26 that is directed toward a distal edge 28 of the second panel 22. Fasteners, such as screws for example, can be extended through the slots 24 and engage the exterior wall 14 for attaching the brackets 12 to the exterior wall 14.

The pair of brackets 12 includes a first bracket 30 and a second bracket 32. The first panel 20 of the first bracket 30 has a pair of wells 34 that is each recessed into the first surface 26 of the first panel 20 of the first bracket 30. The wells 34 are spaced apart from each other and are aligned with a respective one of the slots 24 in the second panel 22 of the first bracket 30. The first panel 20 of the second bracket 32 has a pair of first pins 36 each coupled to and extending away from the first surface 26 of the first panel 20 of the second bracket 32. The first pins 36 are spaced apart from each other and are aligned with a respective one of the slots 24 in the second panel 22 of the second bracket 32. The second panel 22 of the first bracket 30 is mounted to the exterior wall 14 such that the second panel 22 of the first bracket 30 extends downwardly from the second panel 22 of the first bracket 30. The second panel 22 of the second bracket 32 is mounted to the exterior wall 14 such that the second panel 22 of the second bracket 32 extends upwardly from the first panel 20 of the second bracket 32.

A shutter 38 is provided and the shutter 38 is positionable between the pair of brackets 12. The shutter 38 has a pair of attachments 40 that are movably integrated into the shutter 38. Each of the attachments 40 is biased into an engaging condition to releasably engage a respective one of the brackets 12 thereby facilitating the shutter 38 to be quickly coupled to the pair of brackets 12. Conversely, each of the attachments 40 is urgeable into a releasing condition to disengage the respective bracket 12 thereby facilitating the shutter 38 to be quickly removed from the pair of brackets 12.

The shutter 38 has a top edge 42 and a bottom edge 44, and the shutter 38 has a pair of second pins 46 each movably disposed on the top edge 42 such that the pair of second pins 46 defines the attachments 40. Each of the second pins 46 is biased to extend away from the top edge 42 and each of the second pins 46 is compressible toward the top edge 42. Each of the second pins 46 may be spring loaded to bias the second pins 46 upwardly from the top edge 42. The bottom edge 44 has a pair of recesses 48 each extending toward the top edge 42 and the recesses 48 are spaced apart from each other. Each of the recesses 48 insertably receives a respective one of the first pins 36 on the first panel 20 of the second bracket 32.

The shutter 38 is urgeable upwardly when the second pins 46 are inserted into the wells 34 in the first panel 20 of the second bracket 32 thereby facilitating the bottom edge 44 of the shutter 38 to be positioned above the first panel 20 of the second bracket 32. The shutter 38 is subsequently releasable when the bottom edge 44 is positioned above the first panel 20 of the second bracket 32 thereby facilitating each of the recesses 48 in the bottom edge 44 of the shutter 38 to insertably receive a respective one of the first pins 36. In this way the shutter 38 is retained between the first bracket 30 and the second bracket 32.

In use, the shutter 38 is positioned at an angle to facilitate the second pins 46 to extend into the respective wells 34 in the first panel 20 of the first bracket 30. The shutter 38 is urged upwardly to compress the second pins 46 toward the top edge 42 of the shutter 38 and the bottom edge 44 of the shutter 38 is positioned above the first panel 20 of the second bracket 32. The shutter 38 is lowered until each of the first pins 36 extends into the respective recess 48 in the bottom edge 44 of the shutter 38. In this way the shutter 38 is retained between the first bracket 30 and the second bracket 32. The shutter 38 is lifted upwardly to facilitate the first pins 36 to be removed from the recesses 48 and the shutter 38 is then lowered away from the first bracket 30. In this way the shutter 38 is removed from between the first bracket 30 and the second bracket 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A removable shutter assembly for facilitating shutters to be quickly removed and installed on a building, said assembly comprising:
a pair of brackets, each of said brackets being attachable to an exterior wall of a building, each of said brackets being positionable adjacent to a window in the exterior wall, each of said brackets having a first panel being perpendicularly oriented with a second panel; and
a shutter being positionable between said pair of brackets, said shutter having a pair of attachments being movably integrated into said shutter, each of said attachments being biased into an engaging condition to releasably engage a respective one of said brackets thereby facilitating said shutter to be quickly coupled to said pair of brackets, each of said attachments being urgeable into a releasing condition to disengage said respective bracket thereby facilitating said shutter to be quickly removed from said pair of brackets.

2. The assembly according to claim 1, wherein each of said brackets has a pair of slots each being integrated into said second panel, said slots in said second panel of each of said brackets being elongated such that each of said slots has an ovoid shape extending laterally along said second panel, said first panel of each of said brackets having a first surface being directed toward a distal edge of said second panel.

3. The assembly according to claim 2, wherein said pair of brackets includes a first bracket and a second bracket, said first panel of said first bracket having a pair of wells each being recessed into said first surface of said first panel of said first bracket, said wells being spaced apart from each other and being aligned with a respective one of said slots in said second panel of said first bracket.

4. The assembly according to claim 2, wherein said pair of brackets includes a first bracket and a second bracket, said first panel of said second bracket having a pair of first pins each being coupled to and extending away from said first surface of said first panel of said second bracket, said first pins being spaced apart from each other and being aligned with a respective one of said slots in said second panel of said second bracket.

5. The assembly according to claim 1, wherein:
said pair of brackets includes a first bracket and a second bracket;
said second panel of said first bracket is mounted to the exterior wall such that said second panel of said first bracket extends downwardly from said second panel of said first bracket; and
said second panel of said second bracket is mounted to the exterior wall such that said second panel of said second bracket extends upwardly from said first panel of said second bracket.

6. The assembly according to claim 4, wherein said shutter has a top edge and a bottom edge, said shutter having a pair of second pins each being movably disposed on said top edge such that said pair of second pins defines said attachments, each of said second pins being biased to extend away from said top edge, each of said second pins being compressible toward said top edge.

7. The assembly according to claim 6, wherein said bottom edge has a pair of recesses each extending toward said top edge, each of said recesses being spaced apart from each other, each of said recesses insertably receiving a respective one of said first pins on said first panel of said second bracket.

8. The assembly according to claim 7, wherein said shutter is urgeable upwardly when said second pins are inserted into said wells in said first panel of said second bracket thereby facilitating said bottom edge of said shutter to be positioned above said first panel of said second bracket.

9. The assembly according to claim 8, wherein said shutter is releasable when said bottom edge is positioned above said first panel of said second bracket thereby facilitating each of said recesses in said bottom edge of said shutter to insertably receive a respective one of said first pins for retaining said shutter between said first bracket and said second bracket.

10. A removable shutter assembly for facilitating shutters to be quickly removed and installed on a building, said assembly comprising:
a pair of brackets, each of said brackets being attachable to an exterior wall of a building, each of said brackets being positionable adjacent to a window in the exterior wall, each of said brackets having a first panel being perpendicularly oriented with a second panel, each of said brackets having a pair of slots each being integrated into said second panel, said slots in said second panel of each of said brackets being elongated such that each of said slots has an ovoid shape extending laterally along said second panel, said first panel of each of said brackets having a first surface being directed toward a distal edge of said second panel, said pair of brackets including a first bracket and a second bracket, said first panel of said first bracket having a pair of wells each being recessed into said first surface of said first panel of said first bracket, said wells being spaced apart from each other and being aligned with a respective one of said slots in said second panel of said first bracket, said first panel of said second bracket having a pair of first pins each being coupled to and extending away from said first surface of said first panel of said second bracket, said first pins being spaced apart from each other and being aligned with a respective one of said slots in said second panel of said second bracket, said second panel of said first bracket being mounted to the exterior wall such that said second panel of said first bracket extends downwardly from said second panel of said first bracket, said second panel of said second bracket being mounted to the exterior wall such that said second panel of said second bracket extends upwardly from said first panel of said second bracket;
a shutter being positionable between said pair of brackets, said shutter having a pair of attachments being movably integrated into said shutter, each of said attachments being biased into an engaging condition to releasably engage a respective one of said brackets thereby facilitating said shutter to be quickly coupled to said pair of brackets, each of said attachments being urgeable into a releasing condition to disengage said respective bracket thereby facilitating said shutter to be quickly removed from said pair of brackets, said shutter having a top edge and a bottom edge, said shutter having a pair of second pins each being movably disposed on said top edge such that said pair of second pins defines said attachments, each of said second pins being biased to extend away from said top edge, each of said second pins being compressible toward said top edge, said bottom edge having a pair of recesses each extending toward said top edge, each of said recesses being spaced apart from each other, each of said recesses insertably receiving a respective one of said first pins on said first panel of said second bracket, said shutter being urgeable upwardly when said second pins are inserted into said wells in said first panel of said second bracket thereby facilitating said bottom edge of said shutter to be positioned above said first panel of said second bracket, said shutter being releasable when said bottom edge is positioned above said first panel of said second bracket thereby facilitating each of said recesses in said bottom edge of said shutter to insertably receive a respective one of said first pins for retaining said shutter between said first bracket and said second bracket.

11. A method of releasably attaching a shutter to an exterior wall of a building, the steps of the method comprising:
providing a first bracket having a first panel being perpendicularly oriented with a second panel, said first bracket having a pair of wells each being recessed into said first panel;
providing a second bracket having a first panel being perpendicularly oriented with a second panel, said second bracket having a pair of first pins each extending away from said first panel of said second bracket;
providing a shutter having a top edge and a bottom edge, said top edge having a pair of second pins each being movably disposed on said top edge, each of said second pins being biased to extend away from said top edge, each of said second pins being compressible toward said top edge, said shutter having a pair of recesses each being integrated into said bottom edge;
mounting said second panel of each of said first bracket and said second bracket to an exterior wall of a building such that each of said first bracket and said second bracket are positioned on a common vertical axis having said second panel of each of said first bracket and said second bracket being directed toward each other;
positioning said shutter such that each of said second pins extends into a respective one of said wells in said first panel of said first bracket;
lifting said shutter such that said second pins are compressed toward said top edge of said shutter;
positioning said bottom edge of said shutter over said first panel of said second bracket; and
releasing said shutter such that each of said second pins biases said shutter downwardly thereby facilitating each of said second pins to extend into a respective one of said recesses in said bottom edge of said shutter for retaining said shutter between said first bracket and said second bracket.
